(19) United States
(12) Patent Application Publication
(10) Pub. No.: US 2016/0016272 A1
(43) Pub. Date: Jan. 21, 2016

(54) SAW SHEATH THAT FACILITATES REMOVAL OF THE SAW

(71) Applicant: Reliable Tools & Hardware Co., Ltd, Taichung City (TW)

(72) Inventor: Chuan-Wu CHEN, Taichung City (TW)

(21) Appl. No.: 14/332,695

(22) Filed: Jul. 16, 2014

(51) Int. Cl. B23Q 13/00; B65D 25/22

(52) U.S. Cl. CPC B23Q 13/00; B65D 25/22

(57) ABSTRACT

A saw sheath includes an accommodation chamber and an access hole located in a top side of the accommodation chamber for allowing the saw blade of a saw to be inserted through the access hole and accommodated in the accommodation chamber. The cross section of the accommodation chamber defines a long axis direction and a short axis direction perpendicular to the long axis direction. The saw sheath further includes a cross-sectional slot extending from the access hole along the length of the saw sheath in communication with the accommodation chamber in the long axis direction of the accommodation chamber such that the saw can be conveniently moved out of the saw sheath through the cross-section slot in the long axis direction of the accommodation chamber after the saw blade of the saw having been pulled outwards to a certain distance.

### BACKGROUND OF THE INVENTION

1. Field of the Invention

The present invention relates to saw sheath technology, and more particularly, to a saw sheath for holding a saw that facilitates removal of the saw, enhancing ease of use.

2. Description of the Related Art

In architecture, interior decorating, carpentry and horticulture industries, workers will often use a saw during working. After each use, the saw user will receive the saw in a saw sheath, to avoid being cut by the saw blade on the one hand, and to facilitate carrying on the one hand.

However, almost all conventional saw sheaths are designed as a hollow housing. Thus, the user must pull the saw blade of the saw fully out of the saw sheath before using the saw. When pulling the saw blade, the user needs not only to adjust the saw and the saw sheath to a suitable angle for the application of force but also to set aside enough space, preventing the saw blade from getting jammed. Therefore, conventional saw sheath structures need to be improved.

### SUMMARY OF THE INVENTION

The present invention has been accomplished under the circumstances in view. It is the main object of the present invention to provide a saw sheath, which enhances ease of use.

To achieve this and other objects of the present invention, a saw sheath comprises an accommodation chamber and a cross-sectional slot. The accommodation chamber comprises an access hole located in a top side thereof. The cross section of the accommodation chamber defines a long axis direction and a short axis direction in a perpendicular relationship with the long axis direction. The cross-sectional slot extends from the access hole along the saw sheath in communication with the accommodation chamber in the long axis direction. Further, the length of the cross-sectional slot is at least one half of the length of the saw sheath.

When going to take out the saw, pull the saw to move saw blade outwards to a certain distance and then move the saw out of the accommodation chamber through the cross-sectional slot in the long axis direction of the cross section of the accommodation chamber. Thus, the saw can be conveniently taken out of the saw sheath, preventing a jam during the operation and enhancing ease of use.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an oblique top elevational view of a saw sheath in accordance with the present invention.

FIG. 2 is an exploded view of the saw sheath in accordance with the present invention.

FIG. 3 is a top view of the saw sheath in accordance with the present invention.

FIG. 4 is an end view of the present invention after removal of the locating end member from the sheath shell.

FIG. 5 is a side view of the present invention illustrating the saw held in the saw sheath.

FIG. 6 is a top view of the present invention, illustrating the saw held in the saw sheath.

FIG. 7 is an end view of the present invention, illustrating the saw held in the saw sheath.

FIG. 8 is similar to FIG. 5, illustrating the positioning block of the saw disengaged from the positioning notch of the saw sheath.

FIG. 9 is similar to FIG. 8, illustrating the saw blade of the saw moved out of the accommodation chamber through the cross-sectional slot.

FIG. 10 is similar to FIG. 1, illustrating the saw sheath hung on the body belt at an opposite side.

### DETAILED DESCRIPTION OF THE INVENTION

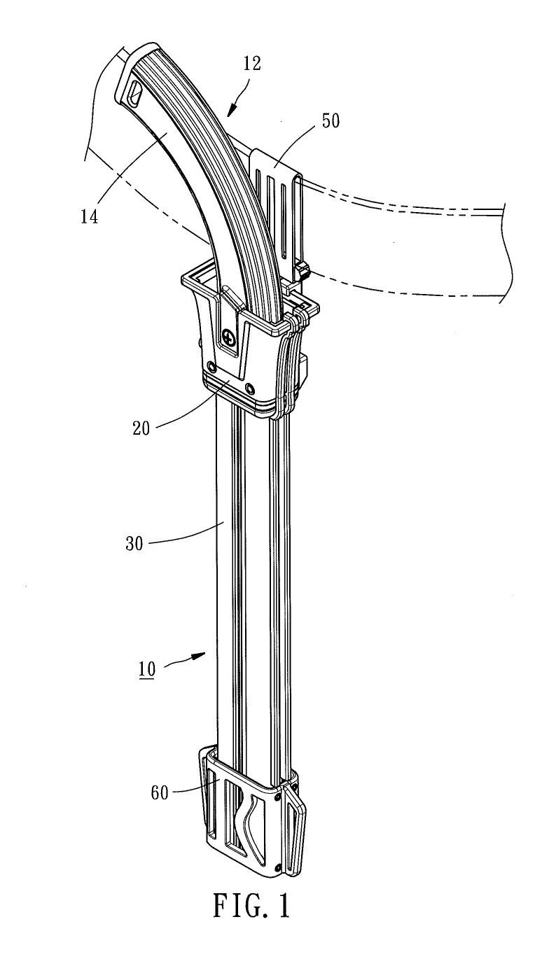

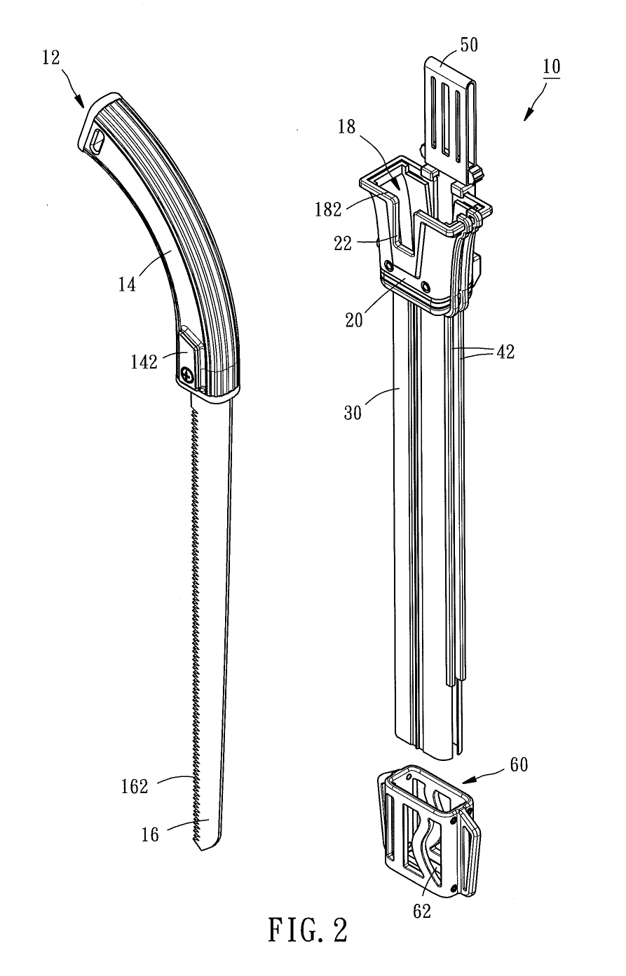

Referring to FIGS. 1 and 2, a saw sheath 10 in accordance with the present invention is shown. The saw sheath 10 is adapted for holding a hand saw 12 that comprises a saw handle 14, and a saw blade 16 having a series of teeth 162 connected to the saw handle 14.

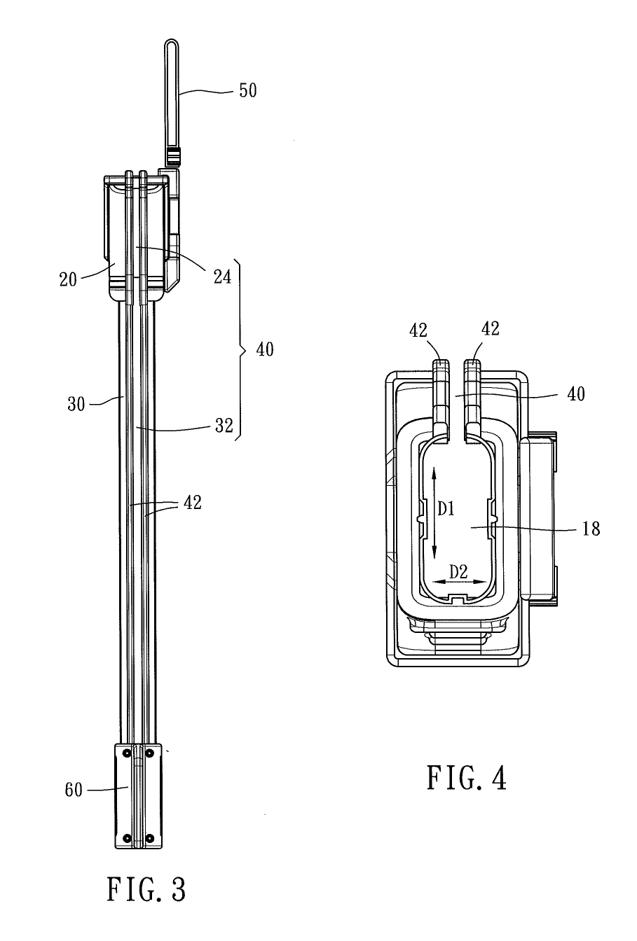

Referring to FIG. 3 and FIG. 2 again, the saw sheath 10 comprises a saw handle holder 10 that comprises a positioning notch 22 located in an outer side thereof for the positioning of a positioning block 142 of the saw handle 14, and a sheath shell 30 that has a top end thereof connected to the saw handle holder 20 and defines with the saw handle holder 20 an accommodation chamber 18 that has an access hole 182 located in a top side thereof within the saw handle holder 20.

Referring to FIGS. 4-7, the cross section of the accommodation chamber 18 defines a long axis direction D1 and a short axis direction D2 in a perpendicular relationship relative to each other. The long axis direction D1 of the cross section of the accommodation chamber 18 is disposed in parallel to the width direction of the saw blade 16 of the saw 12. The short axis direction D2 of the cross section of the accommodation chamber 18 is disposed in parallel to the thickness direction of the saw blade 16 of the saw 12. Further, as shown in FIGS. 3 and 4, the saw handle holder 20 further comprises a first slot segment 24; the sheath shell 30 comprises a second slot segment 32. The first slot segment 24 of the saw handle holder 20 and the second slot segment 32 of the sheath shell 30 are connected in a line, constituting a cross-sectional slot 40 that is kept in communication with the accommodation chamber 18 in the long axis direction D1 of the cross section of the accommodation chamber 18 and extended from the access hole 182 along the length of the saw sheath 10 to at least one half of the length of the saw sheath 10. In this embodiment, the length of the cross-sectional slot 40 is preferably equal to the length of the saw sheath 10.

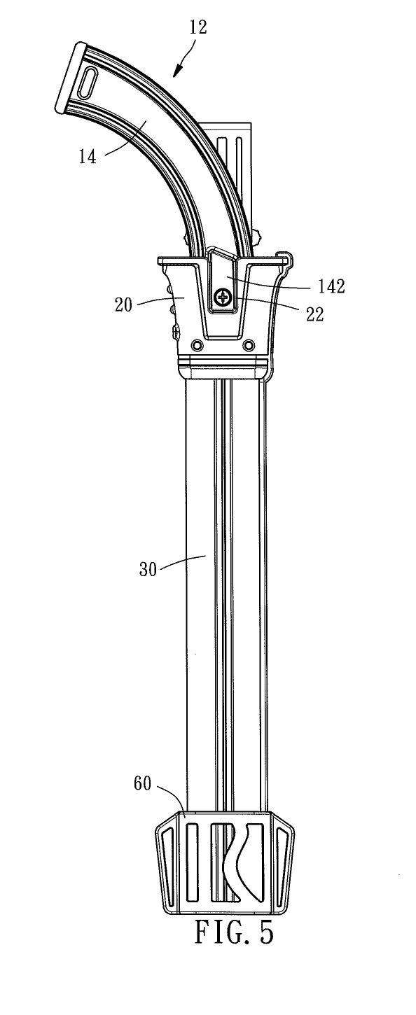

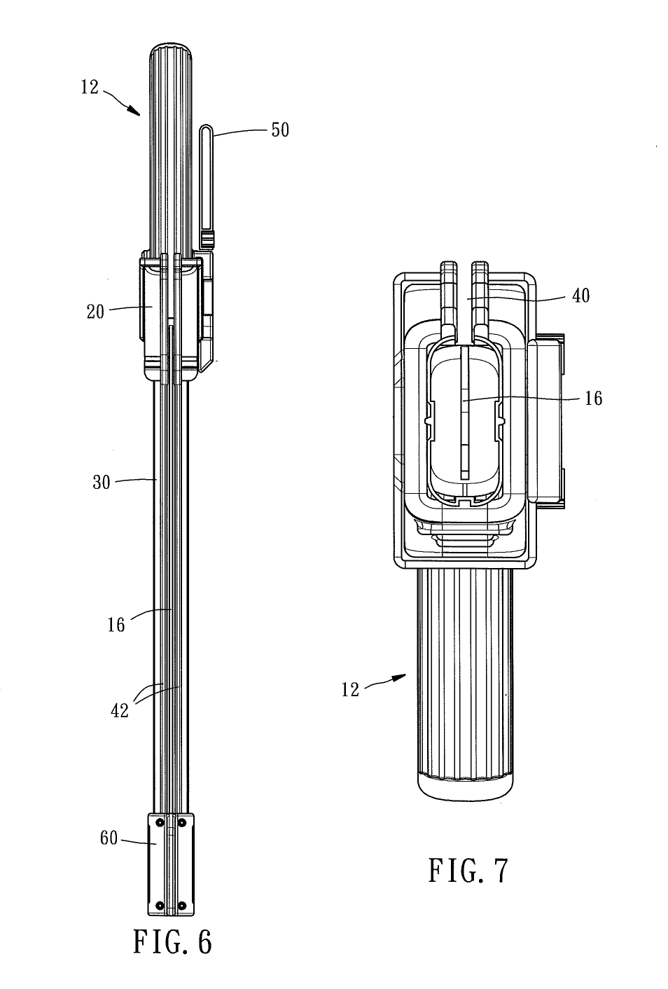

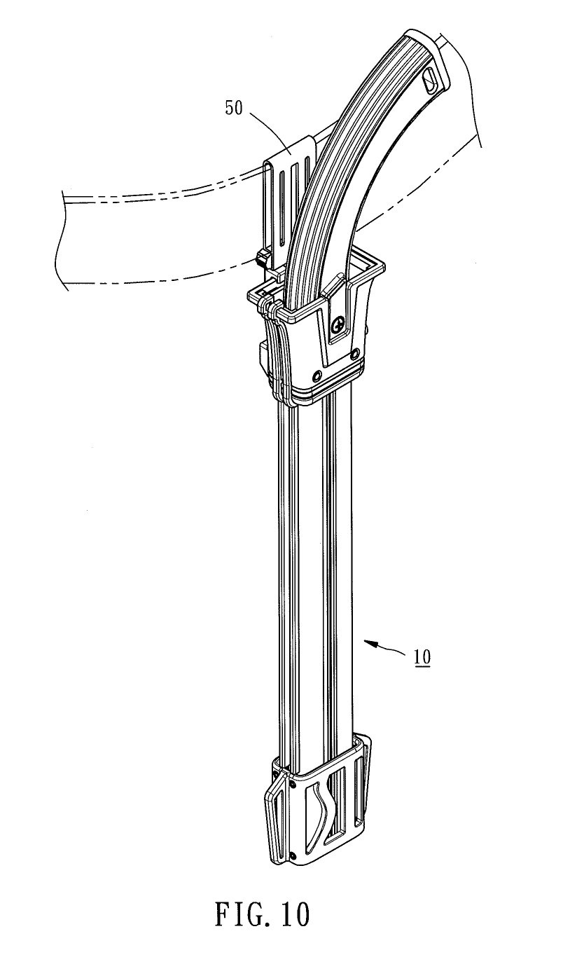

On the other hand, as shown in FIG. 14 and FIG. 2, the saw sheath 10 further comprises a hanger 50 that can be selectively mounted at the left side or right side of the saw handle holder 20 so that different users can adjust the position of the hanger 50 for allowing the saw sheath 10 to be hung on the body belt at the left side (see FIG. 10) or right side (see FIG. 1), enhancing ease of use. The saw sheath 10 further comprises a locating end member 60 attached to an opposing bottom end of the sheath shell 30. The locating end member 60 comprises a stop bar 62 located at a bottom side thereof. The stop bar 62 is disposed in the bottom open side of the accommodation chamber 18 in parallel to the long axis direction D1 of the cross section of the accommodation chamber 18 for stopping the saw blade 16 of the saw 12 in place. Thus, when going to receive the saw 12 in the saw sheath 10, insert the saw blade 16 of the saw 12 through the access hole 182 into the accommodation chamber 18 of the saw sheath 10 to force the positioning block 142 of the saw handle 14 into engagement with the positioning notch 22 in the saw handle holder 20 of the saw sheath 10, as shown in FIGS. 5 and 6, completing the receiving of the saw 12.

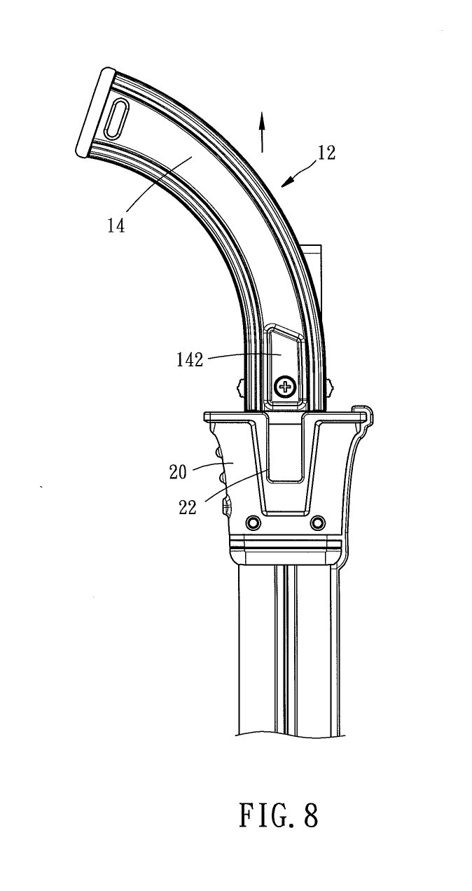

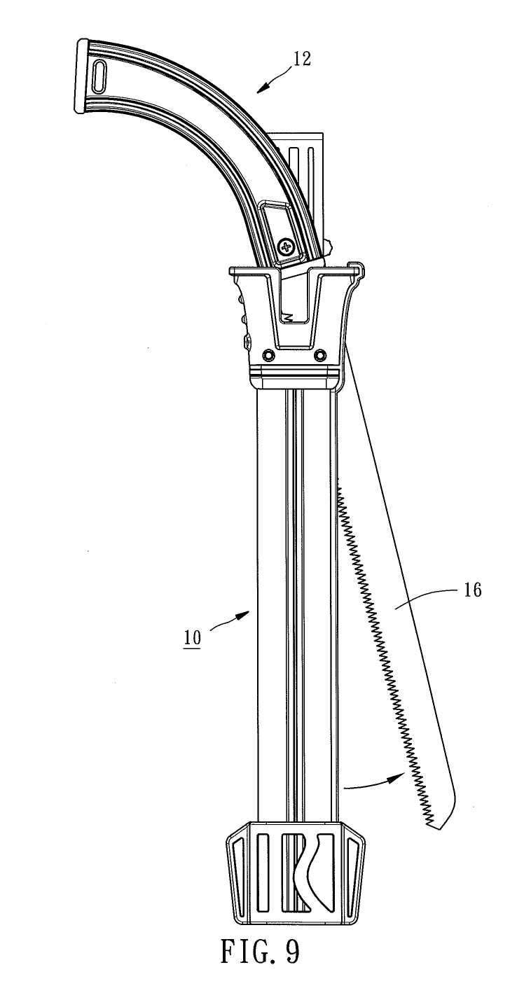

When going to use the saw 12, pull the saw 12 outwards to a certain distance, as shown in FIG. 8, to disengage the positioning block 142 of the saw handle 14 from the positioning notch 22 of the saw handle holder 20 of the saw sheath 10, and then move the saw 12 out of the accommodation chamber 18 in the long axis direction D1 of the cross section of the accommodation chamber 18, as shown in FIG. 7 and FIG. 9. At this time, the saw blade 16 of the saw 12 is moved out of the accommodation chamber 18 through the cross-sectional slot 40. Further, to guard rails 42 are respectively arranged along two opposite lateral sides of the cross-sectional slot 40 to protect the border area of the cross-sectional slot 40 of the saw sheath 10 from being damaged by the teeth 162 of the saw blade 16 (see FIG. 3 and FIG. 6).

In conclusion, the design of the cross-sectional slot 40 of the saw sheath 10 allows the user to take the saw 12 out of the saw sheath 10 by pulling the saw 12 outwards to a certain distance and then moving the saw 12 in the long axis direction of the cross section of the accommodation chamber 18, preventing a jam during the operation and enhancing ease of use.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. A saw sheath, comprising an accommodation chamber and a cross-sectional slot, said accommodation chamber comprising an access hole located in a top side thereof, the cross section of said accommodation chamber defining a long axis direction and a short axis direction in a perpendicular relationship with said long axis direction, said cross-sectional slot extending from said access hole along said saw sheath in communication with said accommodation chamber in said long axis direction, the length of said cross-sectional slot being at least one half of the length of said saw sheath.

2. The saw sheath as claimed in claim 1, further comprising a saw handle holder and a sheath shell, said sheath shell having a top end thereof fixedly connected to said saw handle holder in such a manner that said sheath shell and said saw handle holder defining therein said accommodation chamber, said accommodation chamber having the top side thereof defined in said saw handle holder to form said access hole.

3. The saw sheath as claimed in claim 2, wherein said saw handle holder comprises a positioning notch located in one side thereof.

4. The saw sheath as claimed in claim 2, further comprising a hanger detachably mounted at one side of said saw handle holder.

5. The saw sheath as claimed in claim 2, further comprising locating end member mounted at an opposing bottom end of said sheath shell, said locating end member comprising a stop bar disposed in a bottom side of said accommodation chamber in parallel to the longitudinal direction of the cross section of said accommodation chamber.

6. The saw sheath as claimed in claim 1, further comprising two guard rails respectively arranged along two opposite lateral sides of said cross-sectional slot.

7. The saw sheath as claimed in claim 1, wherein the length of said cross-sectional slot is equal to the length of said saw sheath.
